(19) United States
(12) Patent Application Publication
(10) Pub. No.: US 2007/0253095 A1
(43) Pub. Date: Nov. 1, 2007

(54) Pattern write method and demagnetization state determination method

(75) Inventors: Kazuhiko Washizu, Kanagawa (JP); Atsushi Takeichi, Kanagawa (JP); Masashi Murayama, Kanagawa (JP); Takaaki Ogita, Kanagawa (JP)

Correspondence Address: TOWNSEND AND TOWNSEND AND CREW LLP, TWO EMBARCADERO CENTER, 8TH FLOOR, SAN FRANCISCO, CA, 94111, US

(73) Assignee: Hitachi Global Storage Technologies Inc., Amsterdam (NL)

(21) Appl. No.: 11/796,516

(22) Filed: Apr. 26, 2007

(30) Foreign Application Priority Data
Apr. 26, 2006 (JP) 2006-122744

(51) Int. Cl. G11B 5/596; G11B 5/03; G11B 21/02

(52) U.S. Cl. 360/77.08; 360/75; 360/66

(57) ABSTRACT

Embodiments in accordance with the present invention control pitch variations that are not observed in self servo write (SSW). According to one embodiment of the present invention, an outer radius side area of a magnetic disk is erased using an external magnetic field, and an inner radius side area is subjected to self erase using a head. The magnetization state in the base of the inner radius side area is different from that of the outer radius side area before pattern writing. Therefore, in the inner radius side area and the outer radius side area, even if a radial pattern of the same pitch is read, the different APCs are measured. With SSW of this embodiment, a reference APC used in the inner radius side area is different from that used in the outer radius side area. In this manner, the pitch variation is prevented.

### CROSS-REFERENCE TO RELATED APPLICATION

The instant nonprovisional patent application claims priority to Japanese Application No. 2006-122744, filed Apr. 26, 2006 and incorporated by reference in its entirety herein for all purposes.

### BACKGROUND OF THE INVENTION

A disk drive device is a device using a recording disk that can vary in type, such as an optical disk, a magneto-optical disk, a flexible magnetic disk, and others. Among these, a hard disk drive (HDD) has become widespread as a storage device for a computer, and is regarded as a storage device that is essential for the current computer system. The computer system is not the only possibility, however, and the range of uses of the HDD is increasingly expanding due to its superior characteristics. The range of uses include a removable memory for use with a moving image recording/reproducing device, a vehicle navigation system, a mobile phone, a digital camera, and others.

A HDD is provided with a magnetic disk, a spindle motor (SPM) for rotatably-driving the magnetic disk, a head element section for execution of data writing and reading to/from the magnetic disk, an actuator that supports the head element section and moves the head element section to any desired position, and others. The HDD includes a cabinet that houses therein the components. The cabinet includes, generally, a base with an aperture portion, and a board-like top cover covering the aperture portion of the base.

After the components are assembled inside of the base, the top cover is used to cover the aperture portion of the base so that the assembly is completed. After the assembly is completed, the magnetic disk is written with a servo pattern. The HDD through writing of a servo pattern, is supplied to various types of tests for product shipping. When the writing of the servo pattern itself is determined as faulty, the servo pattern then needs to be erased. Moreover, because test data is also written during the tests for product shipping, for the HDD that is determined as being faulty, the test data also needs to be erased.

For performing erase to a magnetic disk, Japanese Laid-Open Patent No. 317125 (“Patent Document 1”) discloses a technique of performing erase in a state that a magnetic disk is attached to an HDD. With this technique, the outer radius side of the magnetic disk is erased using an external magnetic field generated by a permanent magnet, and the inner radius side thereof is erased by a head element section of the HDD.

Patent Document 1 points out that a magnetic height-difference is observed between an area erased using the head element section and an area erased by the external magnetic field. In Patent Document 1, this magnetic height-difference affects a self servo write (SSW) process, and changes the track pitch of servo data at any portion observed with the magnetic height-difference. In consideration thereof, with this technique, the track pitch is monitored in the SSW, and when any pitch change due to the magnetic height-difference is found, the entire area of the recording surface is erased by the head element section.

With the SSW, control is exercised from an external circuit over a spindle motor in an HDD and a voice coil motor (VCM) that drives an actuator using only the mechanical mechanism of the HDD body, and a product servo pattern is written using the external circuit. In this manner, the cost is reduced for a servo writer.

With the SSW, utilizing the fact that a read element and a write element of a head element section are positioned at each different position in the radius direction (in this specification, this is referred to as read/write offset), the head element section is positioned while the read element reads a pattern already written to the inner radius side or the outer radius side, and the write element writes any new pattern to a desired track with a space of read/write offset. With the SSW, in addition to a product servo pattern, the remaining patterns are written on the recording surface, and with these utilized, control is exercised over the head position and the timing.

With the SSW, because no external positioning mechanism is used, for determining a distance between servo write tracks, a pattern is read for any tracks adjacent with some position overlay in the radius direction, and the resulting value (in this specification, referred to as APC) is used therefor. It is known that the APC is under the great influence of the initial state of the recording surface, and shows a varying value depending on the initial state (base magnetization state) no matter if the patterns are disposed at physically the same interval.

As is disclosed in Patent Document 1, when the outer radius side of the magnetic disk is erased by an external magnetic field generated by a permanent magnet, and when the inner radius side is erased by the head element section of the HDD, the magnetization state (demagnetization state) of the base varies in the respective areas. Therefore, in these areas, the patterns sharing the same interval may show each different APC. With the SSW, the APC measurement is performed to any patterns written in the course thereof, and sequentially feeds the head in such a manner that the value suits the reference APC that is set in advance. As such, when the same reference APC is used to both the outer radius side and the inner radius side, the study shows that the track pitch demonstrates some change.

### BRIEF SUMMARY OF THE INVENTION

Embodiments of the present invention control pitch variations that are not observed in self servo write. According to the particular embodiments shown in FIGS. 5 and 7, an outer radius side area 212 of a magnetic disk 11 is erased using an external magnetic field, and an inner radius side area 211 is subjected to self erase using a head. The magnetization state in the base of the inner radius side area is different from that of the outer radius side area before pattern writing. Therefore, in the inner radius side area and the outer radius side area, even if a radial pattern 117 of the same pitch is read, the different APCs are measured. With SSW of this embodiment, a reference APC used in the inner radius side area is different from that used in the outer radius side area. In this manner, the pitch variation is prevented.

### BRIEF DESCRIPTION OF THE DRAWINGS

FIG. 1 is a diagram schematically showing the technique of erasing a magnetic disk recording surface in an head disk assembly (HDA) using an external magnetic field according to embodiments of the present invention.

FIG. 2 is a diagram schematically showing the logical configuration of an HDA, and that of a servo write control device that exercises control over servo write of the HDA according to embodiments of the present invention.

FIG. 3 is a diagram schematically showing the internal mechanism of the HDA according to embodiments of the present invention.

FIG. 4 is showing a data format of a product servo pattern of one servo sector according to embodiments of the present invention.

FIG. 5 is schematically showing a write pattern to be written by an SSTW on the recording surface, and a writing method thereof according to embodiments of the present invention.

FIG. 6 is schematically showing an example of positioning a read element at a target position, and writing a pattern using a write element according to embodiments of the present invention.

FIG. 7 is a diagram schematically showing an inner radius side area in which a head element section performs self erase, and an outer radius side area in which an external magnetic field is used for erase according to embodiments of the present invention.

FIG. 8 is a diagram schematically showing a servo pattern write sequence including an erase process in the inner radius side area according to embodiments of the present invention.

FIG. 9 is a diagram schematically showing a change observed in a track pitch in pattern write immediately after a calibration sequence is executed according to embodiments of the present invention.

FIG. 10 is schematically showing a method of moving the read element in an APC calibration sequence according to embodiments of the present invention.

### DETAILED DESCRIPTION OF THE INVENTION

Embodiments in accordance with the present invention relate to a pattern write method to a magnetic recording surface, and a demagnetization state determination method on the magnetic recording surface.

An embodiment of the present invention is directed to a method of writing a pattern on a rotating magnetic recording surface using a head including a read element and a write element disposed at each different position in the radius direction. With this method, in a first area of the magnetic recording surface, in such a manner that a value to be calculated from a value derived by the read element reading a pattern written by the write element at a different radius position follows a first reference, the write element sequentially writes a new pattern while the pattern written by the write element is being read sequentially by the read element for positioning. Moreover, in a second area having a base magnetization state different from the first area, in such a manner that a value to be calculated from a value derived by the read element reading a pattern written by the write element at a different radius position follows a second reference being different from the first reference, the write element sequentially writes a new pattern while the pattern written by the write element is being read sequentially by the read element for positioning. Using each different reference for two areas enables the accurate application of head control in accordance with the base magnetization state.

Embodiments of the present invention are especially effective when the first area is erased by the write element, and when the second area is erased by an external magnetic field.

In the second area, a plurality of patterns each at a different radius position, may be written by the write element, and using a value derived by reading the patterns by the positioned read element, the second reference is calculated from the first reference. This enables the derivation of the second reference with ease and accuracy.

Preferably, a determination is made whether the base magnetization state is satisfactory or not based on an amount of change observed in the value to be calculated in the second area with respect to the value to be calculated in the first area. Alternatively, preferably, in the second area, a determination is made whether the base magnetization state is satisfactory or not based on a variation observed in the value to be calculated plurally for the same radius position. Still alternatively, in the second area, a determination is preferably made whether the base magnetization state is satisfactory or not based on a variation observed in the value to be calculated plurally for a different radius position. By making a determination to see satisfactory or not, it can prevent pattern write based on erroneous calculation of the second reference.

Another embodiment of the present invention is directed to a method of writing a pattern on a rotating magnetic recording surface using a head including a read element and a write element disposed at each different position in a radius direction. With the method, in a first area, a plurality of patterns written by the write element at each different radius position are read by the read element at a first radius position, and a target is determined based on a value calculated using values being reading results and a first reference corresponding to the first radius position. Moreover, the patterns written by the write element are read by the read element and the head is positioned at the target, and in the state with the head positioned, a new pattern is written by the write element. In a second area, a plurality of patterns written by the write element at each different radius position are read by the read element at a second radius position, a second reference is calculated from the first reference based on a value to be calculated using values being reading results, and a new target is determined in accordance with the second reference. Further, the patterns written by the write element are read by the read element and the head is positioned at the new target, and in the state with the head positioned, a new pattern is written by the write element. Using each different reference for two areas enables the accurate application of head control depending on which area.

Still another embodiment of the invention is directed to a method of making a determination about a demagnetization state on a magnetic recording surface. With this method, a plurality of patterns written by the write element at each different radius position are read by the read element after positioning, and using values being reading results, a first comparison value is calculated. Moreover, a plurality of patterns written by the write element at each different radius position are read by the read element after positioning, and using values being reading results, a second comparison value is calculated. Further, based on a difference between the first and second comparison values, a determination is made whether the erasing state is satisfactory or not.

For each of the plurality of different radius positions, the plurality of patterns written by the write element at each different radius position are read by the positioned read element, and using values being reading results, a comparison value is calculated, and based on a variation observed in the comparison values at the plurality of different radius positions, a determination can be made whether the erasing state is satisfactory or not.

For a plurality of different positions in the circumferential direction at the same radius position, the patterns written by the write element at each different radius position are read by the positioned read element, and using values being reading results, a comparison value is calculated, and based on a variation observed in the comparison value plurally calculated at the same radius position, a determination can be made whether the erasing state is satisfactory or not.

According to embodiments of the present invention, a pattern of any desired pitch can be written in a plurality of areas varying in magnetization state.

In the below, described is an embodiment to which the present invention is applicable. For explicit reference, the following description and the accompanying drawings are not fully made or entirely shown as appropriate. In the respective drawings, any similar component is provided with the same reference numeral, and for explicit reference, once-described matters are not described again as required. In the below, a preferred embodiment of the present invention is described with exemplary servo write of a hard disk drive (HDD) being an example of a magnetic disk drive device. The embodiment is characterized in the technique of, with servo write, writing a pattern to areas varying in base magnetization state.

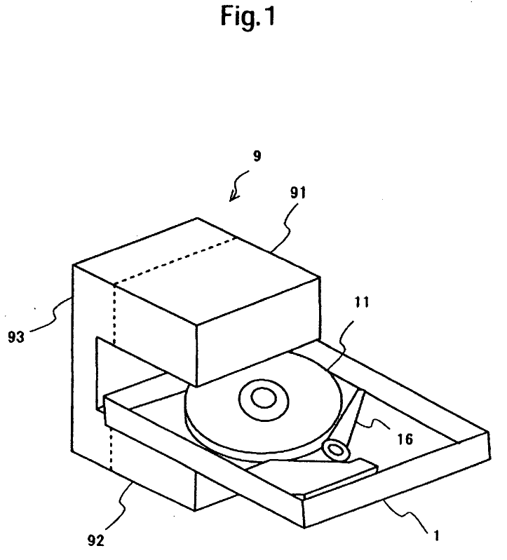

For manufacturing an HDD of the embodiment, first an external magnetic field is used to erase an area on the outer radius side of a magnetic disk, which is incorporated inside of a head disk assembly (HDA). Thereafter, through control over the internal mechanism inside of the HDA, pattern writing is performed to the magnetic disk inside of the HDA. Described first is erasing by the external magnetic field. FIG. 1 is a diagram schematically showing the method of disk erase using an external magnetic field. An external magnetic field generation device 9 generates a magnetic field, and erases the recording surface of a magnetic disk 11 incorporated to the HDA 1. For description, although FIG. 1 is showing the HDA 1 with a top cover removed, in the state that the HDA 1 is attached with the top cover, disk erase can be performed. In FIG. 1, exemplified are the magnetic disk 11 and an actuator 16 incorporated inside of a base 10.

The external magnetic field generation device 9 is provided with permanent magnets 91 and 92, and a magnet support section 93 that supports the permanent magnets 91 and 92. The permanent magnets 91 and 92 are disposed to face each other with a space therebetween. In the space between the permanent magnets 91 and 92, a magnetic field is generated by the permanent magnets 91 and 92. Into this space, the HDA 1 is partially inserted, and in this state, the magnetic disk 11 is rotated using a spindle motor (SPM: not shown) so that the area on the outer radius side of the magnetic disk 11 is erased. The magnetic force of the magnetic field formed by the permanent magnets 91 and 92 is stronger than the force of retaining the magnetic disk 11. In this sense, this external magnetic field can erase the data recorded on the magnetic disk 11. By using the external magnetic field, erasing can be swiftly performed to the magnetic disk 11.

The magnetic field generated between the permanent magnets 91 and 91 is directed vertical or parallel with respect to the recording surface of the rotating magnetic disk 11. The direction of the external magnetic field can be changed depending on the recording method of the magnetic disk 11 to be incorporated inside of the HDA. In order not to affect the external magnetic field to the SPM, inside of the external magnetic field, only a part of the area on the outer radius side of the magnetic disk 11 is inserted. Therefore, the area on the inner radius side of the magnetic disk 11 is not erased to a full degree. In this sense, in the embodiment, by the servo write performed to the magnetic disk 11, the area on the inner radius side is erased by the head element section of the HDA 1.

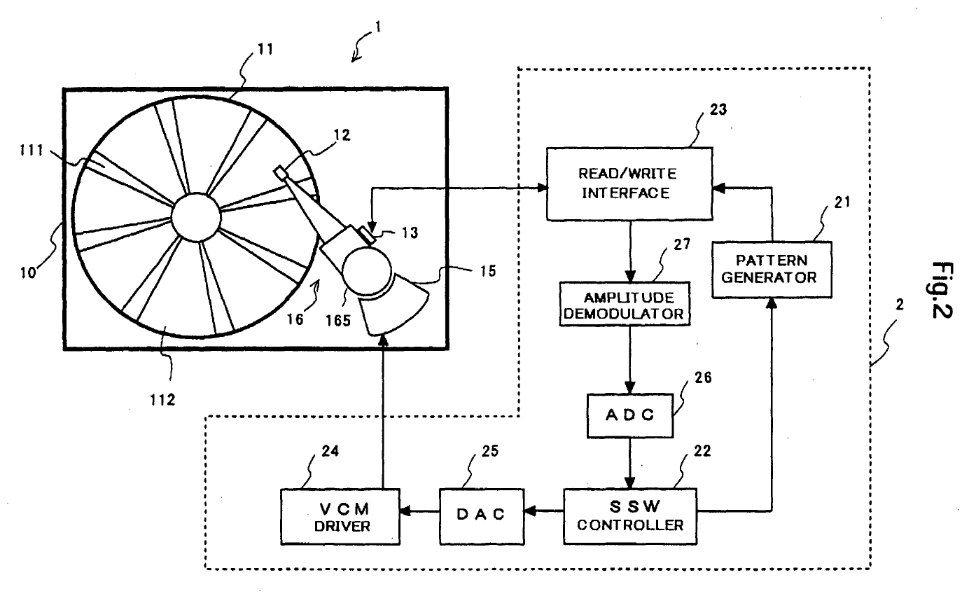

Described next is the servo write in this embodiment. FIG. 2 is a block diagram schematically showing the logical configuration of the HDA 1 and that of a servo write control device 2 that exercises control over servo write of the HDA 1. The HDA 1 is a component of the HDD, including a cabinet 10 provided with a base and a top cover that seals the upper aperture. The HDA 1 includes, in the cabinet, a magnetic disk 11 accommodated therein, a head slider 12, a preamplifier IC 13 being an exemplary circuit element, a voice coil motor (VCM) 15, and the actuator 16. The actuator 16 supports, at its tip end portion, the head slider 12. The preamplifier IC 13 is fixed to the actuator 16 via a circuit board (not shown), specifically, is fixed in the vicinity of a circular axis 161 thereof.

The HDD is also provided with, in addition to the HDA 1, a circuit board fixed to the outside of the cabinet 10. On the circuit board, an IC is incorporated for execution of signal processing and control processing. With servo write in this embodiment, the circuit on this circuit board for control use is not used, and the servo write control device 2 exercises control over the servo write. With the servo write in this embodiment, the internal mechanism of the HDA 1 is directly controlled, and the magnetic disk 11 is written with servo data (servo patterns). The magnetic disk 11 is a nonvolatile storage disk that stores data by a magnetic layer being magnetized.

Such servo write is referred to as self servo write (SSW). With the SSW, using the components inside of the cabinet 10, the magnetic disk 11 is written with the servo data for use for writing and reading of user data. In the below, this servo data is referred to as product servo pattern. Note here that the servo write in this embodiment can be performed using the control circuit incorporated on the HDD.

The servo write control device 2 performs the SSW in this embodiment while exercising control thereover. The servo write control device 2 includes an SSW controller 22. This SSW controller 22 exercises control over the SSW in its entirety. The SSW controller 22 exercises control over positioning of the head slider 12, control over pattern generation, and others. The SSW controller 22 can be configured by a processor that operates in accordance with a micro code that is stored in advance. The SSW controller 22 executes control processing in accordance with a request coming from any external information processing device, and forwards any necessary information such as error information to the information processing device.

At the time of pattern writing to the magnetic disk 11, the SSW controller 22 issues a command to a pattern generator 21, and the pattern generator 21 generates any predetermined pattern. A read/write interface 23 goes through a conversion process for the pattern generated by the pattern generator 21, and forwards a pattern signal to the preamplifier IC 13. The preamplifier IC 13 amplifies the signal for transfer to the head slider 12, and the head slider 12 writes the pattern to the magnetic disk 11.

The SSW controller 22 exercises control over the actuator 16 using the signal read by the head slider 12, and moves and positions the head slider 12. To be specific, the signal read by the head slider 12 is input to an amplitude demodulator 27 via an RW interface 23. The read signal having been subjected to the demodulation process by the demodulator 27 is subjected to AD conversion by an AD converter 26, and the result is input to the SSW controller 22. The SSW controller 22 analyzes the resulting digital signal, and calculates a value control signal.

The SSW controller 22 forwards the value to a DA converter 25. The DA converter 25 subjects the acquired data to DA conversion, and provides a control signal to a VCM driver 24. Based on the control signal, the VCM driver 24 supplies a control current to the VCM 15, and moves and positions the head slider 12. In this specification, the device including the components except for the servo write control device 2 and the magnetic disk 11 of the HDA 1, is referred to as self servo track writer (SSTW). That is, the SSTW takes charge of servo pattern writing onto the recording surface of the magnetic disk 11.

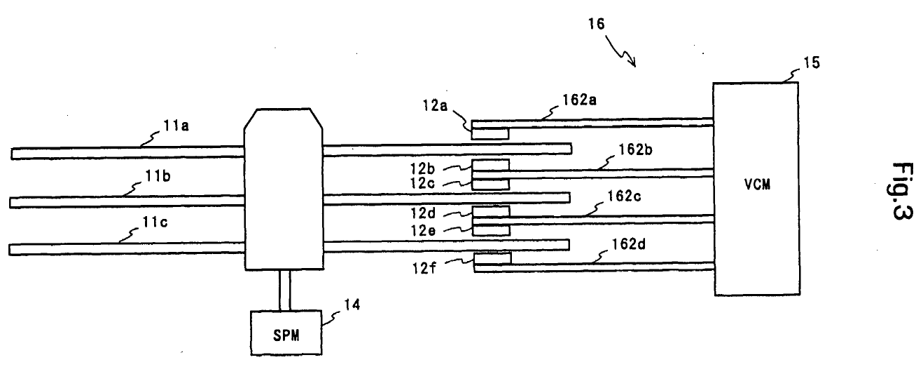

As shown in FIG. 3, the HDA 1 of this embodiment includes a plurality of magnetic disks 11a to 11c, and the magnetic disks 11a to 11c are respectively fixed to a rotation axis of a spindle motor (SPM) 14. The SPM 14 rotates the magnetic disks 11a to 11c fixed thereto with a predetermined angular speed. Moreover, the both surfaces of the respective magnetic disks 11a to 11c are the recording surfaces, and the HDA 1 includes a plurality of head sliders 12a to 12f, which respectively correspond to the recording surfaces.

The head sliders 12a to 12f are all fixed to the actuator 16. Specifically, an actuator arm 162a supports the head slider 12a, an actuator arm 126b supports the head sliders 12b and 12c, an actuator arm 162c supports the head sliders 12d and 12e, and an actuator arm 162d supports the head slider 12f.

The actuator 16 is coupled to the VCM 15, and rotates about the circular axis 161, thereby moving the head sliders 12a to 12f in the radius direction on the recording surfaces of the magnetic disks 11a to 11c. The head sliders 12a to 12f are each provided with a slider, and a head element section (not shown) serving as a thin film element formed thereto. The head element section is provided with a write element that converts an electric signal into a magnetic field in accordance with write data, and a read element that converts the magnetic field from the magnetic disk 11 into an electric signal.

The preamplifier IC 13 selects any one head slider from the plurality of head sliders 12a to 12f for data reading, and amplifies (preamplifies) a reproduction signal reproduced by the selected head slider using a fixed gain. The result is output to the servo write control device 2. The preamplifier IC 13 amplifies the signal coming from the servo write control device 2, and outputs the result to the selected head slider. At the time of product servo pattern writing, all of the head sliders 12a to 12f are selected at the same time.

Referring back to FIG. 2, with the SSW, the magnetic disk 11 is formed with, on its recording surface, a plurality of servo areas 111 that extend radially from the center of the magnetic disk 11 in the radius direction, and are formed for every predetermined angle. FIG. 2 is exemplarily showing seven servo areas. The servo areas 111 are each recorded with a product servo pattern for positioning control over the head sliders at the time of reading/writing of user data. An area between any two adjacent servo areas 111 is a data area 112, and the user data is recorded thereon. The servo areas 111 and the data areas 112 are disposed alternately for every predetermined angle.

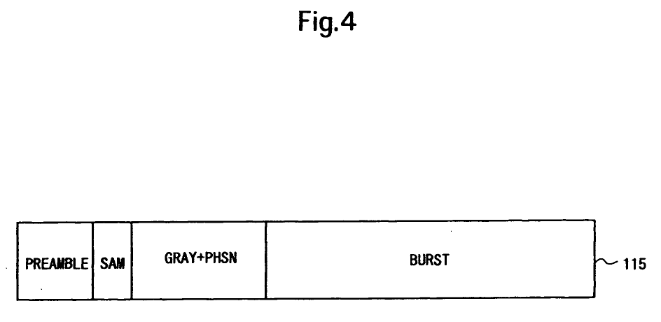

FIG. 4 shows a data format of a product servo pattern 115 of one servo sector. In one servo area 111, the product servo pattern -115 is formed for one servo sector in the circumferential direction, and in the radius direction, the product servo pattern 115 is formed for a plurality of servo sectors. The product servo pattern 115 is configured by a preamble (PREAMBLE), a servo address mark (SAM), a track ID being a gray code (GRAY), a servo sector number (PHSN) (optional), and a burst pattern (BURST). The SAM is a portion indicating at which the actual information such as track ID begins, and has the precise correlation with the position on the magnetic disk 11 written with a SAM signal, which is a timing signal that is generally issued when the SAM is found.

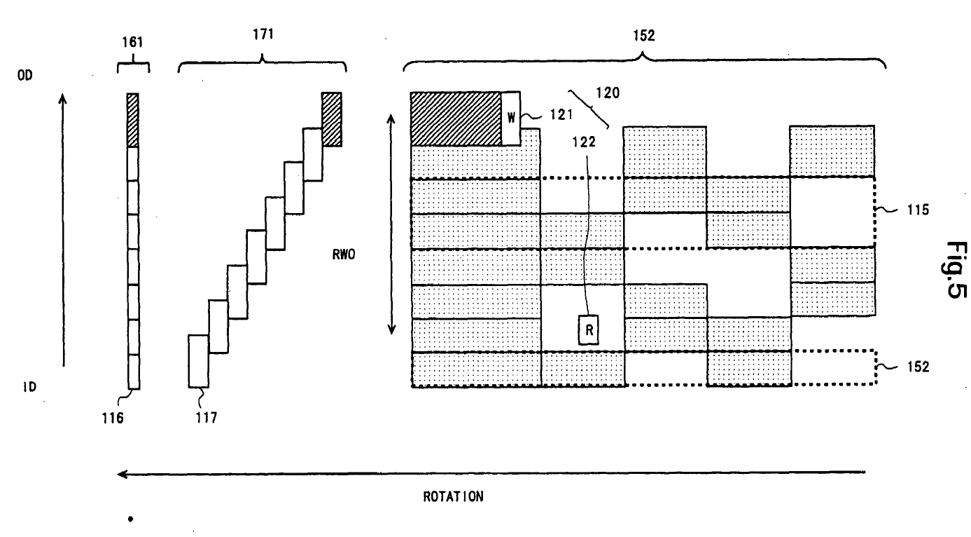

The burst pattern (BURST) is a signal that indicates the more precise position of the servo track indicated by the track ID. The burst pattern typically includes four amplitude signals of A, B, C, and D in a staggered format with a slight positional difference on an orbit for every servo track (refer to FIG. 5). These bursts are each a single frequency signal of the same cycle as the preamble (PREAMBLE).

FIG. 5 is schematically showing a pattern to be written onto the recording surface with the SSTW of this embodiment, and a method of writing the pattern. FIG. 5 is showing a pattern corresponding to one servo sector. The SSTW writes a timing pattern 116 and a radial pattern 117 in addition to the product servo pattern 115. The timing pattern 116 is a pulse pattern, and the radial pattern 117 is a burst of a predetermined frequency. Accordingly, one sector with the SSW in this embodiment includes an area 151 for writing of the product servo pattern 115, an area 161 for writing of the timing pattern 116 of one slot, and an area 171 for writing of the radial pattern 117 of one slot. The timing pattern 116 and the radial pattern 117 are written to the data area 112 that stores therein the user data.

With the SSTW, the pattern written for its own to the magnetic disk 11 is referred to, and using the temporal and spatial information derived from the signal, the next pattern is written to the position displaced by read/write offset in the radius direction while the head element section 120 is being controlled temporally (timing control in the circumferential direction) and spatially (position control in the radius direction).

The read/write offset (RWO) is a space in the head element section 120 in the radius direction between the write element 121 and the read element, and specifically, a distance between the center of the read element 122 and that of the write element 121 on the magnetic disk 11 in the radius direction. The read/write offset varies depending on the radius position on the magnetic disk 11. Note here that the write element 121 and the read element 122 show some position difference also in the circumferential direction, and the space in this direction is referred to as read/write separation.

With the SSTW in this embodiment, a selection is made from a plurality of head element sections 120 (e.g., the head element section of the head slider 12b in FIG. 3), and the selected head element section 120 is used to read the pattern on the recording surface. This head element section 120 is referred to as propagation head in this specification. With the SSTW, the signal read by the propagation head is used to exercise control over the actuator 16, and using all of the head sliders 12a to 12f, the pattern writing is performed simultaneously onto the respective recording surfaces.

In this embodiment, as shown in FIG. 5, the read element 122 is disposed on the side of the inner radius (ID) of the magnetic disk 11 compared with the write element 121. The pattern writing is performed from the inner radius side to the outer radius side. With pattern writing started from the inner radius side, the pattern previously written by the write element 121 can be read by the read element 122. This enables the write element 121 to perform any new pattern writing while positioning the head element section 120 using the pattern read by the read element 122. Note here that it is also possible to start the SSW from the outer side of the magnetic disk 11 by changing the positions of the write element 121 and the read element 122.

More specifically, with the SSTW, the head element section 120 is positioned using the radial pattern 117, and with the timing pattern 116 used as a reference, the timing is measured for pattern writing. After a lapse of time predetermined by the timing at which the read element 122 of the propagation head reads the timing pattern, the write element 121 of each of the head element sections 120 writes the product servo pattern 115 (a part thereof). The timing pattern 116 for the next sector is written based on the reading of the timing pattern 116 of the preceding sector.

As shown in FIG. 5, the write element 121 writes the respective product servo patterns 115 in such a manner as to derive partial overlay in the radius direction. That is, for formation of the product servo patterns, the patterns are each partially written over the pattern on the outer radius side. FIG. 5 shows three already-written product servo patterns 115, and the write element 121 is in the process of forming another product servo pattern counted fourth from the inner radius side.

The write element 121 writes a half of the product servo pattern with a cycle of the magnetic disk. In this specification, the track corresponding to the half of the product servo pattern is referred to as servo write track. The product servo pattern of one servo write track is denoted by 115. Moreover, the track of the product servo pattern is referred to as servo track. The track pitch of the servo write track is a half of the servo track pitch. FIG. 5 example shows a case that seven servo write tracks are already written, and the write element 121 is in the process of writing another servo write track counted eighth from the inner radius side.

The timing pattern 117 in any one specific sector is formed at the position substantially the same in the circumferential direction. On the other hand, the radial patterns 117 are each formed at the position different from, in the circumferential direction, the radial pattern 117 adjacent thereto in the radius direction. That is, some position displacement is observed in the circumferential direction between any adjacent radial patterns 117. In the radius direction, some overlay is observed between any adjacent radial patterns 117. Note that, in FIG. 5, some sequential displacement is observed toward the right side of the drawing as the radial patterns 117 are directed to the outer radius direction, and in the track on the outer radius side, writing is performed to the position displaced toward the left side of the drawing.

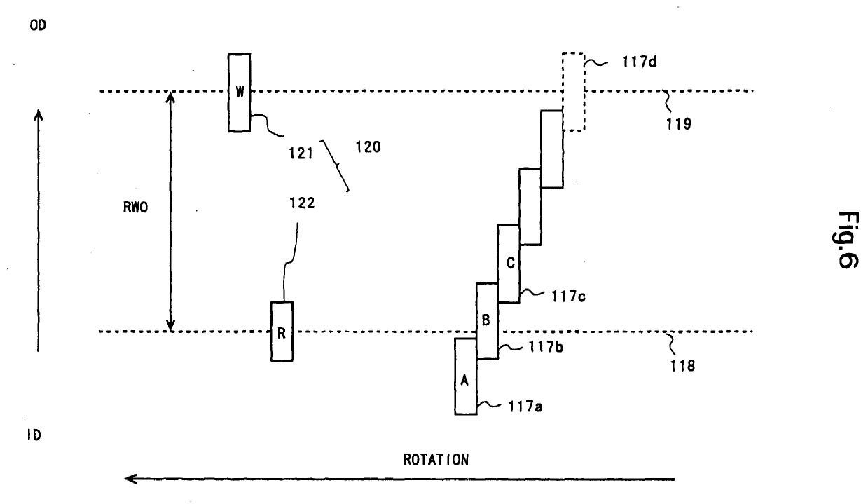

The SSW controller 22 performs head positioning using the read signal of the radial pattern 117. Specifically, by referring to FIG. 6, described is a case of positioning the read element 122 at a target position 118. In FIG. 6, in the radius direction, the dimension of the read element 122 corresponds to the read width, and the dimension of the write element 121 corresponds to the write width. The magnetic disk 11 rotates from right to left of the drawing, and the read element 122 moves from left to right of the drawing. The write element 121 writes the servo write track corresponding to the target position 119.

For positioning of the write element 121 at a target position 119, the SSW controller 22 moves the read element 122 from the target position 119 for positioning at the target position 118 located inner radius side of the read/write offset (RWO). The read element 122 reads radial patterns 117a, 117b, and 117c. The SSW controller 22 calculates a function value (in this specification, referred to as PES value) of the amplitudes (A, B, and C) of the respective radial patterns 117a, 117b, and 117c, and positions the read element 122 in such a manner that the value becomes the target value.

In the state that the read element 122 is positioned at the target position 118, the write element 122 writes the radial pattern 117d. Note that, in the pattern write process, typically, the target position of the read element 122 does not come to the center of the respective radial patterns 117, and is displaced in the radius direction.

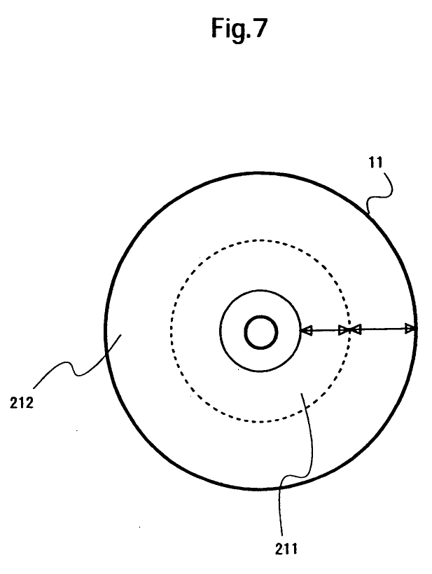

As such, the SSTW sequentially performs pattern writing to the servo write tracks starting from the inner radius side. As described by referring to FIG. 1, the area on the outer radius side of the recording surface of the magnetic disk 11 is subjected to an erase process by the external magnetic field, but the area on the inner radius side is not fully subjected to the erase process by the external magnetic field. Therefore, as shown in FIG. 7, the SSTW of this embodiment performs, for an inner radius side area 211 of each of the recording surfaces, self erase using the corresponding head element section 120. For an external radius side area 212, the SSTW does not perform self erase, but performs pattern writing to the respective recording surfaces.

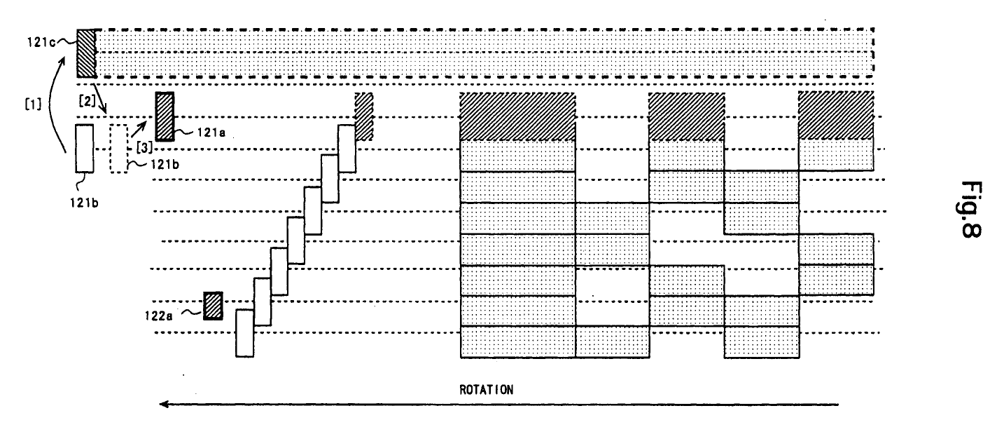

By referring to FIG. 8, described is a pattern write method in the inner radius side area 211. In the inner radius side area 211, in a servo pattern write sequence including an erase process, a pattern write process including the product servo pattern 115 in the target servo write track (hereinafter, servo pattern write process) is repeated together with an erase process at the position with a few servo write tracks away from the pattern-written position.

Specifically, by referring to FIG. 8, the write element 121 at a write element position 121b performs writing of a pattern including a product servo pattern at the target track. Thereafter, the write element 121 is moved to a write element position 121c with a few tracks away toward the outer radius side from the current position [1]. The write element 121 performs erase at the servo write track being a movement destination so that an erase track is generated. In the erase process, a DC erase pattern or an AC erase pattern is written.

When the magnetic disk 11 is rotated once, and when the erase is completed for the track being the movement destination, the write element 121 is returned to the servo write track (write element position 121b) to which the pattern writing is performed immediately therebefore [2]. Moreover, the write element 121 is moved to the outwardly-adjacent servo write track for writing of a pattern including the next product servo pattern 115 [3], and at the write element position 121a, pattern writing is performed. The read element position at this time is denoted by 122a.

Thereafter, with the servo pattern write sequence in the inner radius side area 211, a seek process for any to-be-erased servo write track, an erase process for the seek destination, a seek process for position return before the seeking, another seek process for the outwardly-adjacent servo write track, and a servo pattern write process for the seek destination are repeated.

The servo pattern write sequence in the outer radius side area 212 is the one derived by eliminating the processes for erase from the servo pattern write sequence in the inner radius side area 211. To be specific, in FIG. 8 example, the write element 121 writes a pattern including the product servo pattern 115 at the write element position 121b. Thereafter, the write element 121 seeks a servo write track adjacent to the outer radius side [3], and then writes the patterns at the write element 121a being a seek destination. Thereafter, the seek process to another servo write track adjacent to the outer radius side is repeated together with a servo pattern write process at the seek destination.

The SSW controller 22 in this embodiment sequentially moves the head sliders 12a to 12f in such a manner that a value referred to as APC matches a predetermined value that is previously set. In this manner, a product servo pattern of any desired pitch is written. The SSTW determines a target PES value in such a manner that the APC matches (gets closer to) the predetermined value, and in the state that a propagation head is positioned at the target position, pattern writing is performed at each corresponding servo write track.

The APC is calculated from reading amplitudes A, B, and C of the radial patterns 117 of three servo write tracks, which are adjacent to one another in the radius direction. Specifically, in the state that the propagation head is positioned at the center of one radial pattern 117, the reading amplitudes A, B, and C are acquired respectively for the radial patterns 117. The APC is calculated by (A+C/B).

As shown in FIG. 6, three adjacent radial patterns are adjacent to one another in the radius direction and in the circumferential direction. Moreover, with respect to the radial pattern at the center, the radial patterns adjacent thereto in the radius direction are each partially overlaid in the radius direction. In the circumferential direction, no such overlay is observed for the radial patterns.

Using each different reference APC to the inner radius side area 211 and the outer radius area 212 is counted as one characteristic with the SSW of the embodiment. The magnetization state of the base before pattern writing of the to-be-self-erased inner radius side area 211 is different from that of the outer radius side area 212 to be erased by the external magnetic field. When the read element 122 measures the APC after reading the radial pattern 117, the read element 122 reads also the magnetization of the base portion in addition to the radial pattern 117. Therefore, in the inner radius side area 211 and the outer radius side area 212 each being different in demagnetization state, even if the radial pattern 117 of the same pitch is read, the resulting APCs will be different.

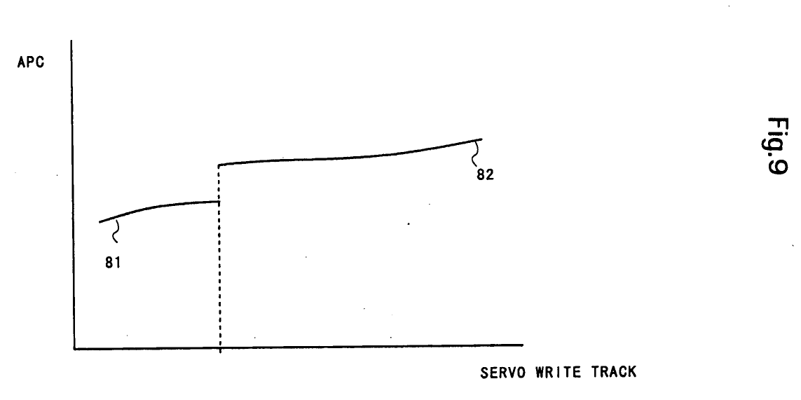

In consideration thereof, at the time of pattern writing in the outer radius side area 212, the reference APC used in the inner radius side area 211 is changed, and any new reference APC is set. FIG. 9 shows an exemplary reference APC curve in this embodiment. For the inner radius side area 211, an APC curve 81 is used, and for the outer radius side area 212, an APC curve 82 is used. Between the APC curve 81 and the APC curve 82, there is a height difference, i.e., an offset. In FIG. 9 example, the APC curve 82 of the outer radius side area 212 is displaced in the direction of increase with respect to the APC curve 81 of the inner radius side area 211, and the relationship inverse thereto is also possible.

With pattern writing performed to the servo write tracks by using the reference APC as a target, control is exercised so as to derive any desired value for the servo write track pitch. Note here that the reference APC is determined in advance in the development stage. Specifically, to make such a determination, a rotary positioner is used to write any ideal pattern in an HDA of the same design, and the APC of the pattern is measured.

The SSTW of this embodiment is set in advance with, before starting the SSW, a reference APC curve corresponding to each of the servo write tracks of the inner radius side area 211 and the outer radius side area 211. That is, at the time when the SSW is started, the areas share the same reference APC curve. In the APC calibration sequence, the SSTW corrects the preset reference APC curve, and sets the APC curve 82 to the outer radius side area 212. Described first is this APC calibration sequence.

With the SSW of this embodiment, after pattern writing is performed for the number of any predetermined servo write tracks, the APC calibration is executed. That is, the SSW of this embodiment includes a plurality of sequences, i.e., includes a pattern write sequence of performing pattern writing sequentially to the servo write tracks on the recording surface, and an APC calibration sequence that is executed between the pattern write sequences.

In the APC calibration sequence, pattern writing is performed with a pitch in accordance with the design. Therefore, the APC of the written pattern is measured, and a PES value is determined for use as a target for the pattern writing thereafter. Such an APC calibration sequence is performed once for every several hundred servo write tracks.

The SSW controller 22 of this embodiment sequentially moves the head element section 120 in such a manner as to derive a predetermined value for the APC. The issue here is that measuring the APC for every movement to the next servo write track requires a considerable amount of time, thereby greatly affecting the yield. In consideration thereof, with the SSW of this embodiment, an APC is measured for every hundreds of servo write tracks, and the resulting measurement value is used as a basis to determine a target PES for the next process.

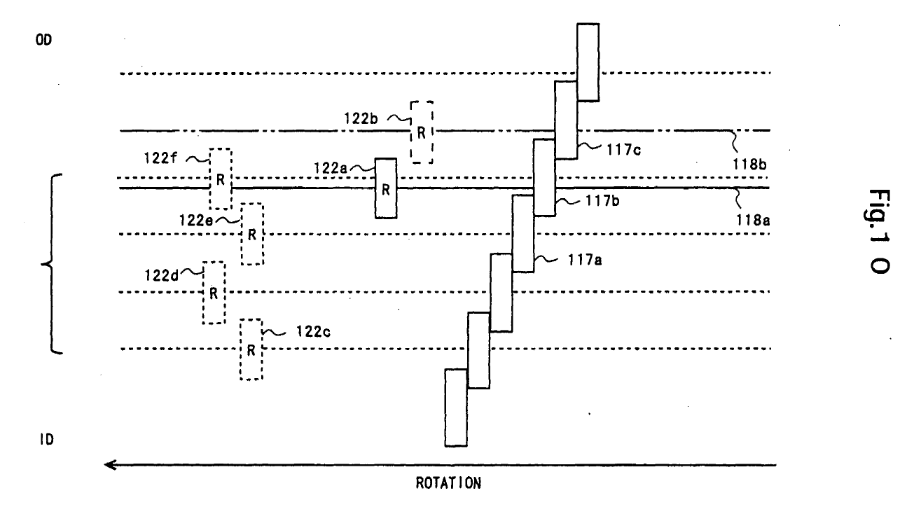

In the APC calibration sequence, as shown in FIG. 10, the read element 122 is moved toward the inner radius side from the target position 11 8a at which pattern writing is performed lastly, and the APC is measured for a plurality of servo write tracks. In FIG. 10, the read element 122 is moved from the lastly-pattern-written position to the inner side for four servo write tracks, and the radial patterns are read while the read element being moved sequentially from the read element position 122c to the read element position 122f. In FIG. 10, the APC of the servo write track is measured. Measuring the APCs of the servo write tracks prevents measurement of erroneous APCs due to measurement errors. The APC measurement is configured by a seek operation and an operation of radial pattern reading, and in the above example, executed are seeking (read) of four disk rotations and radial pattern reading (read) of four disk rotations.

The SSTW sets the APC curve 82 of the outer radius side area 212 in the APC calibration sequence at a predetermined radius position. Typically, at the ACP calibration position at the innermost side of the outer radius side area 212, the SSTW sets again the reference APC curve. As an example, considered here is a case where there is an area boundary at a 4900 servo write track position, and the SSTW performs ACP calibration at a 4800 servo write track position and at a 5000 servo write track position. In this case, the SSTW sets again the reference APC curve during the APC calibration at this 5000 servo write track position.

Specifically, in the APC calibration at the innermost side of the outer radius side area 212, the SSW controller 22 calculates an average value of the APCs for a plurality of servo write tracks (in the above example, four servo write tracks). That is, an APC average value calculated for each of the servo write tracks are added together, and the resulting value is divided by the number of servo write tracks. The SSW controller 22 uses this value to correct (adjust) the reference APC curve that is previously set.

Typically, the reference APC curve is set as a tertiary or quintic function with respect to a servo write track position. The SSW controller 22 compares an APC at the calibration position represented by the initially-set function with the actually-measured APC. Thereafter, a difference between these values is calculated, and the resulting difference is added to the function as an offset. The resulting new function serves as a function that represents the reference APC curve in the outer radius side area 212.

As such, using the APC actually measured in the outer radius side area 212, the function representing the reference APC curve used in the inner radius side area 211 is corrected so that the resulting reference APC curve can be suited to the base magnetization state of the outer radius side area 212. In this manner, the track pitch of the servo data can be controlled not to fluctuate that much.

In order to derive an accurate APC measurement value, as described above, it is preferable to measure a plurality of APCs, and use a value calculated from the resulting values. Moreover, as described above, it is preferable to measure the APC for a plurality of servo write tracks, and use an average value of the resulting values. Alternatively, a possible option is an average value of a plurality of APC values to be measured in one servo write track. Still alternatively, an APC measurement value of one servo write track or that being a part of a plurality of servo write tracks may be used.

As such, the reference APC curve is corrected by APC measurement actually performed in the outer radius side area 212. This APC measurement is thus required to be performed with accuracy. However, when the outer radius side area 212 is erased by the external magnetic field, there may be cases that some area closer to the inner radius side area 211 is not erased to a full degree. As such, APC measurement in an area of poor demagnetization state may result in noise mixture to the measured APC value, and vary a track pitch, which is key for accurate APC measurement.

Thus, there is a need to determine whether a measurement area for correction of a reference APC is satisfactorily demagnetized or not. In the APC calibration, the SSTW of this embodiment uses an APC measurement value being an exemplary comparison value to measure the base magnetization state in the area so that the demagnetization state is determined whether to be satisfactory or not. With the satisfactory demagnetization state, based on the reference APC that is newly set, the SSTW performs pattern writing in a row to the outer radius side area 212.

When the demagnetization state is determined as being not satisfactory, the SSTW stops servo write. For example, the HDA I is removed from the servo write control device, and is subjected again to the erase process using the external magnetic field. Alternatively, the SSTW uses the head element section 120 to subject, to self erase, the area including the area of poor demagnetization area. For example, the SSTW uses the head element section 120 to erase the entire surface of the recording surface. Alternatively, any predetermined area in the vicinity of the boundary is subjected to self erase using the head element section 120. Thereafter, the SSTW resumes pattern writing.

Described now is a method of determining the demagnetization state. The amount of change observed in an APC is counted as one preferable criterion for determining whether the demagnetization is satisfactory or not. The APC measurement value varies to some level depending on the track position; but the variation should never be large. Therefore, when the measurement APC value varies to a level exceeding a fixed value, a determination is made that an erroneous reference APC is about to be set.

To be specific, by using the measurement APC value in the inner radius side area 211 as a basis, the SSW controller 22 makes a comparison with the APC value measured in the outer radius side area 212 when the reference APC is set again. When an amount of value change observed in these comparison values is exceeding an allowable reference range, the SSW controller 22 determines that the demagnetization is not satisfactory.

In accordance with the above example, the SSW controller 22 stores the APC average value derived by the APC calibration at the 4800 track. Then, the APC average value acquired in the APC calibration at the 5000 track is compared with the APC average value in storage. When the difference therebetween falls in the reference range, the SSW controller 22 determines that the demagnetization state is satisfactory. Note here that the APC value for use for such a determination is preferably an average value of a plurality of APC values.

This is not restrictive, and as described above by referring to in the description about re-setting of a reference APC, any other APC values may be used such as an average value in one servo write track. Moreover, using an average value of a plurality of APC values is substantially the same as using the sum of the plurality of APC values. This is similarly applicable also to the description below.

Other preferable determination references use variations observed in the APC values. As one specific technique, in the outer radius side area 212, in the APC calibration, a determination is made based on the variations observed in the APC values in a plurality of servo write tracks. As one preferable example, utilized is dispersion of the APC average value for each of the servo write tracks. In the example described by referring to FIG. 10, the SSW controller 22 performs APC value measurement for the sectors disposed each with a space in the circumferential direction in the four servo write tracks.

The SSW controller 22 uses an APC value for each of the sectors in one servo write track to calculate an APC average value of the servo write track. Similarly to each of other servo write tracks, the SSW controller 22 calculates an APC average value. The SSW controller 22 also uses an APC average value for each of the servo write tracks to calculate dispersion that denotes the variations of the resulting values.

The SSW controller 22 has a reference range that is set in advance, and compares the acquired dispersion with this reference range. When the dispersion is in the reference range, the SSW controller 22 determines that the demagnetization state has no problem (satisfactory state). On the other hand, when the dispersion is not in the reference range, the SSW controller 22 determines that the demagnetization is not satisfactory. Note here that, for accurate measurement, it is preferable to calculate dispersion from the larger number of servo write tracks.

Another preferable technique of using the APC value variation is to use the variation observed in the APC values for each of the sectors in one servo write track. In the APC calibration in the outer radius side area 212, the SSW controller 22 performs APC value measurement for each of the sectors in the selected servo write track. The SSW controller 22 calculates the dispersion of each of the APC values for the sectors.

The SSW controller 22 has a reference range that is set in advance, and compares the acquired dispersion with this reference range. When the dispersion is in the reference range, the SSW controller 22 determines that the demagnetization state has no problem (satisfactory state). On the other hand, when the dispersion is not in the reference range, the SSW controller 22 determines that the demagnetization is not satisfactory. Alternatively, the SSW controller 22 may calculate the dispersion for a plurality of the servo write tracks, and using a plurality of dispersions, determine whether the demagnetization state is satisfactory or not.

As such, three determination criteria are described. Preferably, the SSW controller 22 makes a determination about all of these criteria. After such determination making, when at least one determination criterion out of these is not satisfied, the SSW 22 controller determines that the base is in the poor magnetization state. Note here that the SSW controller 22 is not required to use all of the three determination criteria, and may use one or two determination criteria. Alternatively, when the two or three determination criteria are not satisfied, the SSW controller 22 may determine that the demagnetization state is not satisfactory.

In the above description, the dispersion of APC values in the radius direction (APC dispersion in a plurality of servo write tracks) is used separately from the dispersion of APC values in the circumferential direction (APC dispersion in one servo track). This is not restrictive, and these may be used together. That is, the SSW controller 22 performs APC value measurement for each of the sectors in a plurality of servo write tracks, and calculates the dispersion of the APC values being the measurement results. Utilizing such dispersion, the demagnetization state may be determined as being not satisfactory. Note here that, as a value denoting variation of APC values, a function other than the dispersion may be used.

As such, the present invention is described with exemplary embodiments, but the present invention is not restrictive to the above-described embodiments. Those skilled in the art can devise modifications, additions, and variations for the components of the above-described embodiment without departing from the scope of the present invention with ease. For example, a servo write control function can be provided to a control circuit of an HDD. The determination about the base demagnetization state may be used not only to SSW but also to determine which area to be self-erased in the development stage for HDDs, for example. The re-setting of the reference APC or the determination about the base demagnetization state may not be performed in the APC calibration but may be executed as other independent sequences.

What is claimed is:

1. A method of writing a pattern on a rotating magnetic recording surface using a head including a read element and a write element disposed at each different position in a radius direction, wherein
in a first area of the magnetic recording surface, in such a manner that a value to be calculated from a value derived by the read element reading a pattern written by the write element at a different radius position follows a first reference, the write element sequentially writes a new pattern while the pattern written by the write element is being read sequentially by the read element for positioning, and
in a second area having a base magnetization state different from the first area, in such a manner that a value to be calculated from a value derived by the read element reading a pattern written by the write element at a different radius position follows a second reference being different from the first reference, the write element sequentially writes a new pattern while the pattern written by the write element is being read sequentially by the read element for positioning.

2. The method according to claim 1, wherein
the first area is erased by the write element, and the second area is erased by an external magnetic field.

3. The method according to claim 1, wherein
in the second area, a plurality of patterns each at the different radius position are written by the write element, and using a value derived by reading the plurality of patterns by the positioned read element, the second reference is calculated from the first reference.

4. The method according to claim 1, wherein
a determination is made whether the base magnetization state is satisfactory or not based on an amount of change observed in the value to be calculated in the second area with respect to the value to be calculated in the first area.

5. The method according to claim 1, wherein
in the second area, a determination is made whether the base magnetization state is satisfactory or not based on a variation observed in the value to be calculated plurally for a same radius position.

6. The method according to claim 1, wherein
in the second area, a determination is made whether the base magnetization state is satisfactory or not based on a variation observed in the value to be calculated plurally for a different radius position.

7. A method of writing a pattern on a rotating magnetic recording surface using a head including a read element and a write element disposed at each different position in a radius direction, wherein
in a first area, a plurality of patterns written by the write element at each different radius position are read by the read element at a first radius position, and a target is determined based on a value calculated using values being reading results and a first reference corresponding to the first radius position,
the patterns written by the write element are read by the read element and the head is positioned at the target, and in a state with the head positioned, a new pattern is written by the write element,
in a second area, the plurality of patterns written by the write element at each different radius position are read by the read element at a second radius position, a second reference is calculated from the first reference based on a value to be calculated using values being reading results, and a new target is determined in accordance with the second reference, and
the patterns written by the write element are read by the read element and the head is positioned at the new target, and in a state with the head positioned, a new pattern is written by the write element.

8. The method according to claim 7, wherein
an error determination is made based on an amount of change observed in the value to be calculated in the second area with respect to the value to be calculated in the first area.

9. The method according to claim 7, wherein
an error determination is made based on a variation observed in the value to be calculated plurally at a same radius position in the second area.

10. The method according to claim 7, wherein
an error determination is made based on a variation observed in the value to be calculated plurally at a different radius position in the second area.

11. A method of making a determination about a demagnetization state on a magnetic recording surface, wherein
a plurality of patterns written by the write element at each different radius position are read by the read element after positioning, and using values being reading results, a first comparison value is calculated,
a plurality of patterns written by the write element at each different radius position are read by the read element after positioning, and using values being reading results, a second comparison value is calculated, and
based on a difference between the first and second comparison values, a determination is made whether an erasing state is satisfactory or not.

12. The method according to claim 11, wherein
for each of the plurality of different radius positions, the plurality of patterns written by the write element at each different radius position are read by the positioned read element, and using values being reading results, a comparison value is calculated, and
based on a variation observed in the comparison values at the plurality of different radius positions, a determination is made whether the erasing state is satisfactory or not.

13. The method according to claim 11, wherein
for a plurality of different positions in a circumferential direction at a same radius position, the plurality of patterns written by the write element at each different radius position are read by the positioned read element, and using values being reading results, a comparison value is calculated, and
based on a variation observed in the comparison value plurally calculated at the same radius position, a determination is made whether the erasing state is satisfactory or not.
